(19) United States
(12) Patent Application Publication
(10) Pub. No.: US 2016/0306217 A1
(43) Pub. Date: Oct. 20, 2016

(54) DISPLAY PANELS AND BLIND INCLUDING THE SAME

(71) Applicant: Samsung Display Co., Ltd., Yongin-si (KR)

(72) Inventor: Kyung Tae CHAE, Hwaseong-si (KR)

(21) Appl. No.: 15/056,583

(22) Filed: Feb. 29, 2016

(30) Foreign Application Priority Data
Apr. 14, 2015 (KR) 10-2015-0052687

(51) Int. Cl. G02F 1/1333; G02F 1/1335; E06B 9/40; G02F 1/1368

(52) U.S. Cl. CPC G02F 1/133308; G02F 1/1368; G02F 1/133377; G02F 1/133305; G02F 1/133528; E06B 9/40; G02F 2001/136222

(57) ABSTRACT

The present disclosure relates to a blind, including: an upper fixed part; and a display unit connected to the upper fixed part, wherein the display unit includes: a substrate, a thin film transistor formed on the substrate; a pixel electrode connected to the thin film transistor; a roof layer facing the pixel electrode; and a liquid crystal layer formed as a plurality of microcavities between the pixel electrode and the roof layer, and the display unit is configured to have a first state in which the display unit is wound around the upper fixed part and a second state in which the display unit is unwound out from the upper fixed part.

### CROSS-REFERENCE TO RELATED APPLICATION

This application claims priority to and the benefit of Korean Patent Application No. 10-2015-0052687 filed in the Korean Intellectual Property Office on Apr. 14, 2015, the entire contents of which are incorporated herein by reference.

### BACKGROUND

(a) Field

The present disclosure relates to a display panel and a blind including the same.

(b) Description of the Related Art

With the development of technology demanded by information-oriented societies, a demand for various types of display devices correspondingly increases. Keeping up with the demand, researches into various flat panel display devices including a liquid crystal display device (LCD), a plasma display panel (PDP), an electro luminescent display (ELD), etc., have been conducted in recent years.

Until now, the display devices have been mostly applied to a screen for a television and a monitor for a computer. However, the display device may be applied to other fields besides the screen for television and the monitor for a computer.

With the recent development of display related technologies, flexible display devices or rollable display devices that may be rolled by being curved have been researched and developed.

The display panel may be flexible or rollable using a plastic substrate and may have more improved flexibility by making a thickness of the display panel thin. The flexible display may be used as a two-dimensional form and may also be used as a modified three-dimensional form due to the flexibility thereof.

The above information disclosed in this Background section is only for enhancement of understanding of the background of the disclosure and therefore may contain information that does not form the prior art that is already known in this country to a person of ordinary skill in the art.

### SUMMARY

The present disclosure provides a display panel and a blind including the same capable of expanding applicability of the display devices.

An exemplary embodiment of the present disclosure provides a blind, including: an upper fixed part; and a display unit connected to the upper fixed part, wherein the display unit includes: a substrate, a thin film transistor formed on the substrate; a pixel electrode connected to the thin film transistor; a roof layer facing the pixel electrode; and a liquid crystal layer formed as a plurality of microcavities between the pixel electrode and the roof layer, and the display unit is configured to have a first state in which the display unit is wound around the upper fixed part and a second state in which the display unit is unwound out from the upper fixed part.

The blind may be configured to display an image on the display unit and to block external light when the image is not displayed.

The blind may further include: a lower fixed part connected to a lower portion of the display unit.

The upper fixed part may be formed in a bar shape.

The upper fixed part may be provided with a light source.

A lower portion of the substrate may be provided with a light guide plate.

The substrate may be flexible.

The blind may further include: polarizers formed on a lower portion of the substrate and an upper portion of the roof layer.

The lower fixed part may be provided with a light source.

The blind may further include: a color filter layer formed between the thin film transistor and the pixel electrode.

The roof layer may fill between the liquid crystal layer formed as the plurality of microcavities to form a partition wall.

A region in which the partition wall of the roof layer is not formed may be provided with an inlet.

The pixel electrode may have a plurality of cutouts.

In the display panel and the blind including the same according to an exemplary embodiment of the present disclosure, the display panel is formed of the single substrate and, as a result, may have a thin thickness. Furthermore, the display panel has a structure including a plurality of microcavities and, as a result, may be freely rolled. Therefore, the blind including the display panels may be rolled or unrolled as needed, and as a result serves as the light blocking layer and the display device.

### BRIEF DESCRIPTION OF THE DRAWINGS

FIG. 1 is a diagram illustrating a blind according to an exemplary embodiment of the present disclosure.

FIG. 2 is a diagram illustrating an upper fixed part of the blind according to an exemplary embodiment of the present disclosure.

FIG. 3 is a plan view illustrating a display panel of a display unit according to an exemplary embodiment of the present disclosure.

FIG. 4 is a cross-sectional view taken along the line IV-IV of FIG. 3.

FIG. 5 is a cross-sectional view taken along the line V-V of FIG. 3.

FIG. 6 is a plan view of a display device according to an exemplary embodiment of the present disclosure.

FIG. 7 is a diagram illustrating one pixel of the display device according to the exemplary embodiment of the present disclosure.

FIG. 8 is a cross-sectional view taken along the line VI-VI of FIG. 6.

FIG. 9 is a cross-sectional view taken along the line VII-VII of FIG. 6.

### DETAILED DESCRIPTION OF THE EMBODIMENTS

The present system and method are described more fully hereinafter with reference to the accompanying drawings in which exemplary embodiments of the present system and method are shown. As those skilled in the art would realize, the described embodiments may be modified in various different ways, all without departing from the spirit or scope of the present disclosure.

In the drawings, the thickness of layers, films, panels, regions, etc., are exaggerated for clarity. Like reference numerals designate like elements throughout the specification. It will be understood that when an element such as a layer, film, region, or substrate is referred to as being “on” another element, it may be directly on the other element, or intervening elements may also be present. In contrast, when an element is referred to as being “directly on” another element, there are no intervening elements present.

Hereinafter, a display device according to an exemplary embodiment of the present disclosure is described in detail with reference to the drawings.

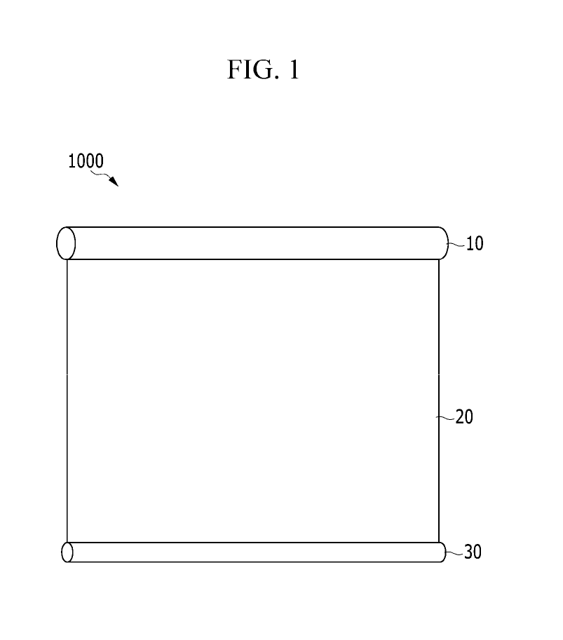

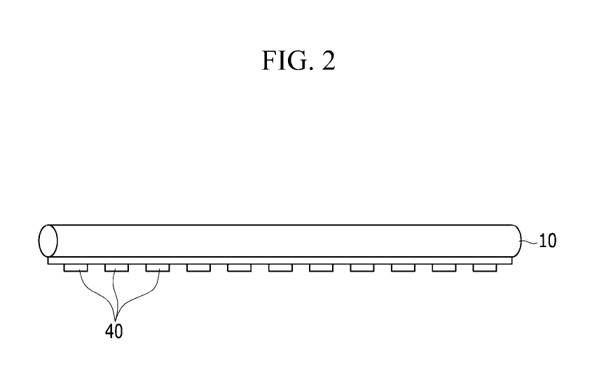

FIG. 1 is a diagram illustrating a blind according to an exemplary embodiment of the present disclosure. FIG. 2 is a diagram illustrating an upper fixed part of the blind according to an exemplary embodiment of the present disclosure.

Referring to FIGS. 1 and 2, a blind 1000 according to an exemplary embodiment of the present disclosure includes an upper fixed part 10, a display unit 20, and a lower fixed part 30. The upper fixed part according to the exemplary embodiment of the present disclosure is provided with light sources 40.

The light sources 40, which may be LEDs, are formed at each fixed part and provide light toward the display unit 20. The light sources 40 may be formed at both of the upper fixed part 10 and the lower fixed part 30 or may be formed only one of the upper fixed part 10 and the lower fixed part 30.

Although not illustrated, the display unit 20 is provided with a light guide plate that guides light incident from the light sources 40 of the fixed part to the display panel formed in the display unit 20.

A light unit including the light source and the light guide plate may provide light to the display panel formed in the display unit to display a screen.

The upper fixed part 10 is formed in a bar shape and serves as a bar and a support around which the display unit 20 is wound. Further, the upper fixed part 10 is provided with a driver, etc., to drive the display panel formed in the display unit 20.

The display unit 20 functions like a curtain of the blind in that the display unit 20 may be wound around the upper fixed part 10 when not being used and may be unwound from the bar when being used.

The display unit 20 according to the exemplary embodiment of the present disclosure includes the display panel and serves as the blind covering light at ordinary times and is driven in response to an electrical signal when displaying an image. To allow the display unit 20 to wound around the bar, the display unit 20 may have flexible characteristics that make it bendable and/or rollable.

The lower fixed part 30 is formed at a lower end of the display unit 20 to keep the form of the flexible display unit 20. Further, the light source 40 is formed at the lower fixed part 30 and thus serves as the light unit.

In some cases, the lower fixed part 30 may be omitted.

Next, the display panel included in the display unit of the blind according to the exemplary embodiment of the present disclosure is described.

First, the display panel of the display unit according to the exemplary embodiment of the present disclosure may include the following structure.

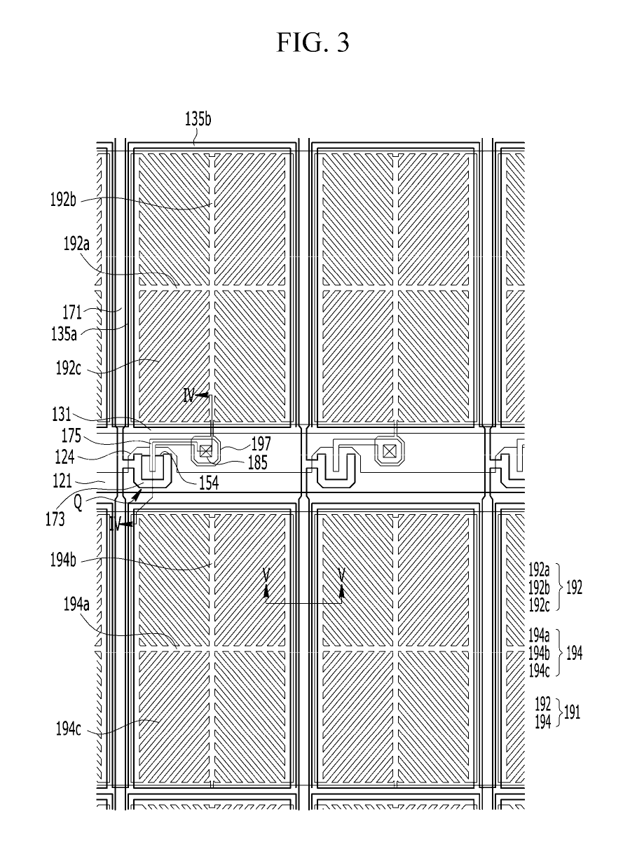

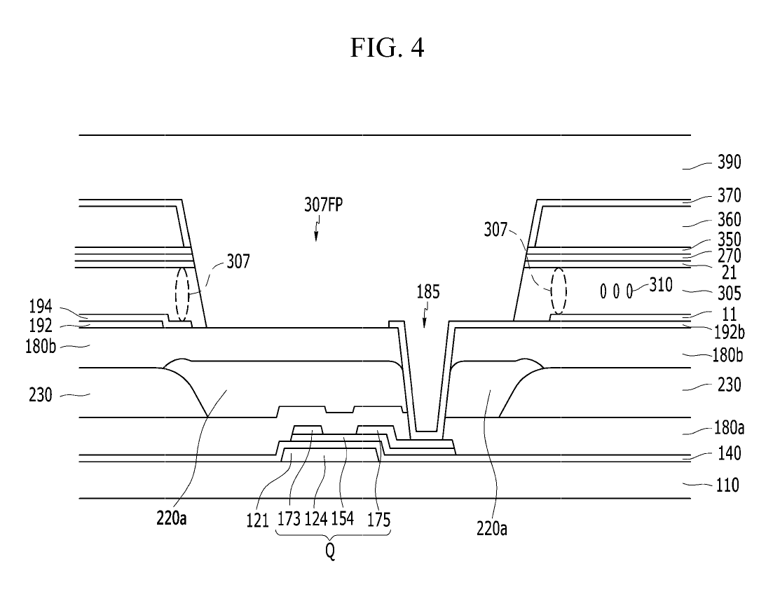

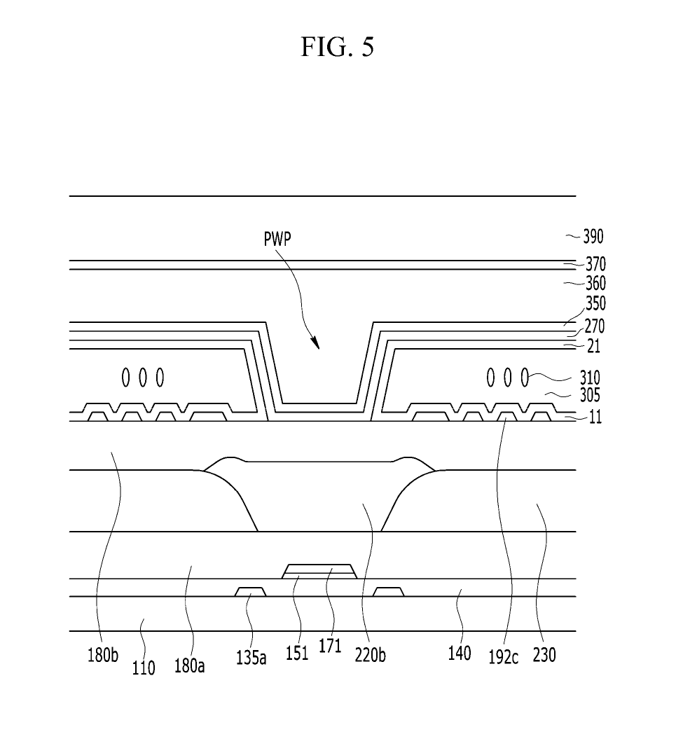

FIG. 3 is a plan view illustrating the display panel of the display unit according to the exemplary embodiment of the present disclosure. FIG. 4 is a cross-sectional view taken along the line IV-IV of FIG. 3. FIG. 5 is a cross-sectional view taken along the line V-V of FIG. 3.

Referring to FIGS. 3 to 5, a gate line 121 and a sustain electrode line 131 are formed on the substrate 110, which may be made of transparent plastic, etc. For example, the substrate 110 may be made of polyimide. The substrate 110 may be a flexible material that may be flexibly bent or curved.

Although not illustrated, the light guide plate may be positioned at the lower portion of the substrate 110. The light guide plate is provided with a pattern, etc., that guides light in a predetermined direction. The light guide plate may be made of a flexible material that may be flexibly bent or curved.

The gate line 121 includes a gate electrode 124. The sustain electrode line 131 extends mainly in a horizontal direction to transfer a defined voltage such as a common voltage Vcom. The sustain electrode line 131 includes a pair of vertical parts 135a that extends substantially vertically to the gate line 121 and a pair of horizontal parts 135b that connects between ends of the vertical parts 135a. The sustain electrodes 135a and 135b have a structure to enclose a pixel electrode 191.

A gate insulating layer 140 is formed on the gate line 121 and the sustain electrode line 131. A semiconductor layer 151 disposed beneath a data line 171, a semiconductor layer 154 disposed beneath source/drain electrodes, and a channel portion of a thin film transistor Q are formed on the gate insulating layer 140.

A plurality of ohmic contacts may be formed on each of the semiconductor layers 151 and 154 and between the data line 171 and the source/drain electrodes. The plurality of ohmic contacts are omitted in the drawings.

Data conductors 171, 173, and 175 including a drain electrode 175, a source electrode 173, and the data line 171 connected to the source electrode 173 are formed on each of the semiconductor layers 151 and 154 and the gate insulating layer 140.

The gate electrode 124, the source electrode 173, and the drain electrode 175 form the thin film transistor Q together with the semiconductor layer 154, and the channel of the thin film transistor Q is formed in the semiconductor layer 154 between the source electrode 173 and the drain electrode 175.

A first interlayer insulating layer 180a is formed on the data conductors 171, 173, and 175 and the exposed semiconductor layer 154. The first interlayer insulating layer 180a may include inorganic insulating materials or organic insulating materials, such as silicon nitride (SiNx) and silicon oxide (SiOx).

Color filters 230 and black matrixes 220a and 220b are formed on the first interlayer insulating layer 180a.

First, the black matrixes 220a and 220b have a lattice structure having an opening corresponding to an area in which an image is displayed and is made of a material through which light is not transmitted. The openings of the black matrixes 220a and 220b are provided with the color filters 230. The black matrixes includes the horizontal black matrix 220a formed along a direction parallel with the gate line 121 and the vertical black matrix 220b formed along a direction parallel with the data line 171.

In some cases, the vertical black matrix 220b may be omitted.

The color filter 230 may display one of the primary colors such as three primary colors of red, green, and blue. The color filter may also display one of cyan, magenta, yellow, white-based colors, without being limited to the three primary colors of red, green, and blue. The color filter 230 may be made of a material displaying different colors in each of the adjacent pixels.

A second interlayer insulating layer 180b is formed on the color filter 230 and the black matrixes 220a and 220b to cover the color filter 230 and the black matrixes 220a and 220b. The second interlayer insulating layer 180b may include inorganic insulating materials or organic insulating materials, such as silicon nitride (SiNx) and silicon oxide (SiOx). Though not shown in FIG. 2, when a step occurs due to a difference between a thickness of the color filter 230 and a thickness of the black matrixes 220a and 220b, the second interlayer insulating layer 180b includes the organic insulating materials, thereby reducing or removing the step.

The color filter 230, the black matrixes 220a and 220b, and the interlayer insulating layers 180a and 180b are provided with contact holes 185 through which the drain electrode 175 is exposed.

The pixel electrode 191 is formed on the second interlayer insulating layer 180b.

The pixel electrode 191 generally has a quadrangle shape and includes a cruciform stem part including horizontal stem parts 192a and 194a and vertical stem parts 192b and 194b intersecting the horizontal stem parts 192a and 194a. Further, the pixel electrode is divided into four sub-areas by the horizontal stem parts 192a and 194a and the vertical stem parts 192b and 194b, and each sub-area includes a plurality of fine branch parts 192c and 194c.

Further, according to the exemplary embodiment of the present disclosure, the pixel electrode may further include an outside stem part enclosing the stem and branch parts of the pixel electrode 191.

A fine branch part 192c/194c of the pixel electrode 191 forms an angle of approximately 40° to 45° with respect to the gate line 121 or the horizontal stem part 192a/194a. Further, the fine branch parts of two adjacent sub-areas may be orthogonal to each other. Further, a width of the fine branch part may become wider and wider, or an interval between the fine branch parts 192c and 194c may be different.

The pixel electrode 191 is connected to lower ends of the vertical stem parts 192b and 194b, includes an extension 197 having an area wider than that of the vertical stem parts 192b and 194b, is physically and electrically connected to the drain electrode 175 from the extension 197 through the contact hole 185, and is applied with a data voltage from the drain electrode 175.

The above-description of the thin film transistor Q and the pixel electrode 191 is only an example. The structure of the thin film transistor and the design of the pixel electrode may be changed to improve side visibility.

A first alignment layer 11, which may be a vertical alignment layer, is formed on the pixel electrode 191. The first alignment layer 11 is a liquid crystal alignment layer of polyamic acid, polysiloxane, polyimide, or the like and may be made of at least one of generally used materials.

A second alignment layer 21 is positioned at a portion opposite to the first alignment layer 11, and a microcavity 305 is formed between the first alignment layer 11 and the second alignment layer 21. A liquid crystal material including liquid crystal molecules 310 is injected into the microcavity 305 through a liquid crystal inlet 307. The microcavity 305 may be formed along a column direction of the pixel electrode 191, for example, a vertical direction. According to the exemplary embodiment of the present disclosure, an alignment material forming the alignment layers 11 and 21 and the liquid crystal material including the liquid crystal molecules 310 may be injected into the microcavity 305 using a capillary force.

The microcavity 305 is divided into a vertical direction by a plurality of liquid crystal injection holes forming regions 307FP, which is positioned at an overlapping portion with the gate line 121, and is also formed in plural along a direction in which the gate line 121 extends. The plurality of microcavities 305 each may correspond to one or at least two pixel areas, and the pixel area may correspond to an area in which a screen is displayed.

A common electrode 270 and a lower insulating layer 350 are positioned on the second alignment layer 21. When the common electrode 270 is applied with a common voltage, it generates an electric field together with the pixel electrode 191 applied with a data voltage to determine the direction in which the liquid crystal molecules 310 positioned in the microcavity 305 between two electrodes is inclined. The common electrode 270 forms a capacitor together with the pixel electrode 191 and thus maintains the applied voltage for a period of time even after the thin film transistor is turned-off. The lower insulating layer 350 may be made of silicon nitride (SiNx), silicon oxide SiO₂, or the like.

Although in the exemplary embodiment of the present disclosure the common electrode 270 is formed on the microcavity 305, the common electrode 270 may be formed beneath the microcavity 305 to drive a liquid crystal depending on a horizontal field mode according to another exemplary embodiment of the present disclosure.

Roof layers 360 are positioned on the lower insulating layer 350. The roof layer 360 serves to support the pixel electrode 191 and the common electrode 270 so that the microcavity 305 may be formed between the pixel electrode 192 and the common electrode 270. The roof layer 360 may include a photoresist or other organic materials.

An upper insulating layer 370 is positioned on the roof layer 360. The upper insulating layer 370 may contact an upper surface of the roof layer 360. The upper insulating layer 370 may be made of silicon nitride (SiNx), silicon oxide SiO₂, or the like.

According to the exemplary embodiment of the present disclosure, a capping layer 390 covers the liquid crystal inlet 307 of the microcavity 305 exposed by the liquid crystal injection hole forming region 307FP while filling the liquid crystal injection hole forming region 307FP. The capping layer 390 includes an organic material or an inorganic material.

According to the exemplary embodiment of the present disclosure, as illustrated in FIG. 3, a partition wall part PWP is formed between the microcavities 305 that are adjacent to each other in a horizontal direction. The partition wall part PWP may be formed along a direction in which the data line 171 extends and may be covered with the roof layer 360. The partition wall part PWP is filled with the lower insulating layer 350, the common electrode 270, the upper insulating layer 370, and the roof layer 360, and the structure may form a partition wall to partition or define the microcavity 305. According to the exemplary embodiment of the present disclosure, since a partition wall structure like the partition wall part PWP is present between the microcavities 305, even when the insulating substrate 110 is curved, a stress may be small, and a cell gap may not change significantly.

Although not illustrated, polarizers may be further formed on upper and lower surfaces of the display panel. The polarizer may be formed of a first polarizer and a second polarizer. The first polarizer may be attached to a lower surface of the substrate 110, and the second polarizer may be attached on the capping layer 390.

Further, a lower portion of the polarizer is provided with the light guide plate, etc., such that light incident from the light source may be dispersed to the entire panel.

Alternatively, the display unit of the blind according to the exemplary embodiment of the present disclosure may include the display panel having the following structure.

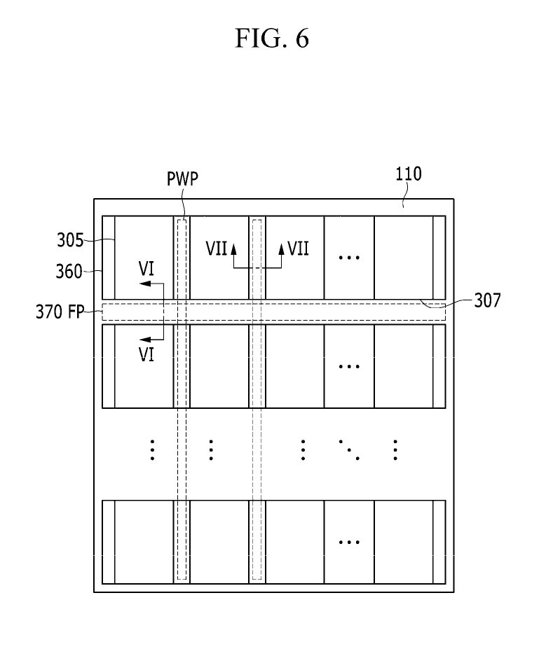

FIG. 6 is a plan view of the display panel according to the exemplary embodiment of the present disclosure.

The display panel according to the exemplary embodiment of the present disclosure includes the substrate 110 that is made of a flexible material such as plastic. The substrate 110 may be made of polyimide.

The microcavity 305, which is covered with the roof layer 360, is formed on the substrate 110. The roof layer 360 extends in a row direction, and the plurality of microcavities 305 is formed under the single roof layer 360.

The microcavity 305 may be disposed in a matrix form, the liquid crystal injection hole forming region 307FP is disposed between the microcavities 305 adjacent to each other in a column direction, and the partition wall part PWP is positioned between the microcavities 305 adjacent to each other in a row direction.

The plurality of roof layers 360 are separated from each other with the liquid crystal injection hole forming region 307FP disposed therebetween. The microcavity 305 at a portion contacting the liquid crystal injection hole forming region 307FP is not covered with the roof layer 360 but may be exposed to the outside when not covered by the capping layer 390. The portion is called the inlet 307. The inlet 307 is formed at an edge of one side of the microcavity 305.

Each roof layer 360 is formed between the adjacent partition wall parts PWPs to be separated from the substrate 110 to form the microcavity 305. That is, the roof layer 360 is formed to cover the rest of the sides other than a side of a first edge at which the inlet 307 is formed. Therefore, the roof layer 360 includes a side wall having three surfaces other than the side of the first edge and an upper surface covering the side wall. In this case, a side positioned at an edge facing the inlet 307 may be a horizontal support member and a side positioned at an edge connected to the horizontal support member to form the side wall may be a vertical support member.

The above-described structure of the display device according to the exemplary embodiment of the present disclosure is only an example and therefore may be variously changed. For example, a disposition form of the microcavity 305, the liquid crystal injection hole forming region 307FP, and the partition wall part PWP may be changed, the plurality of roof layers 360 may also be connected to each other in the liquid crystal injection hole forming region 307FP, a portion of each roof layer 360 may be formed to be separated from the substrate 110 to connect between the adjacent microcavities 305, in the partition wall part PWP.

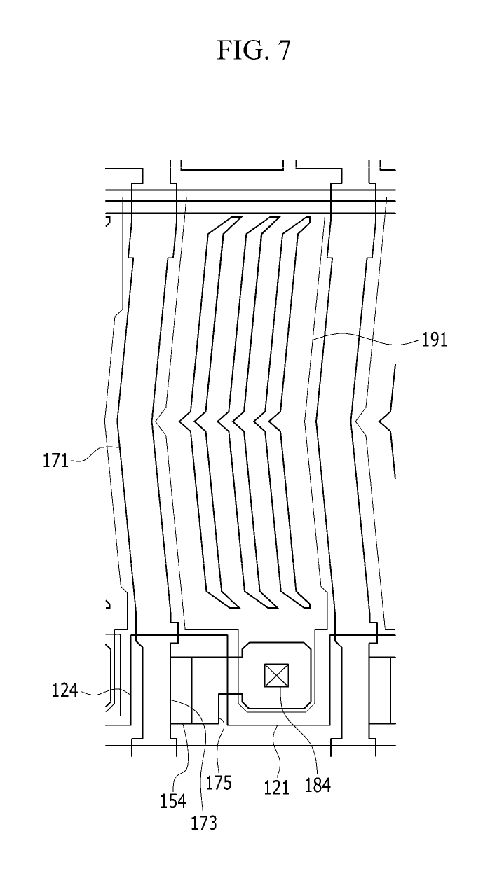

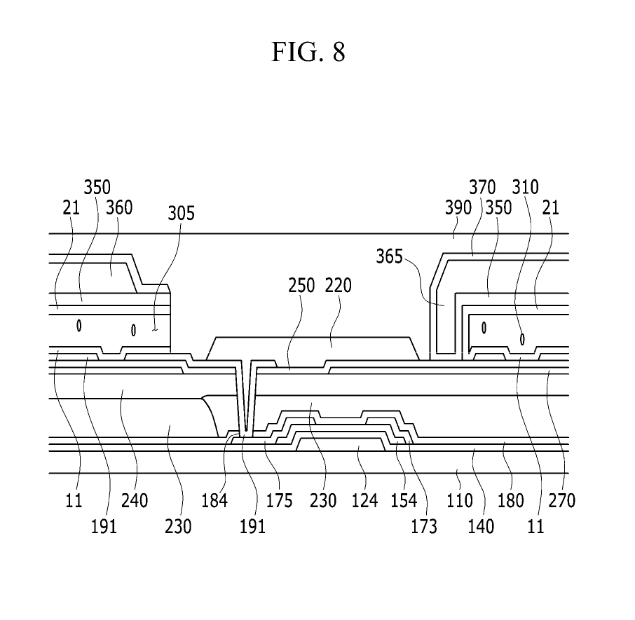

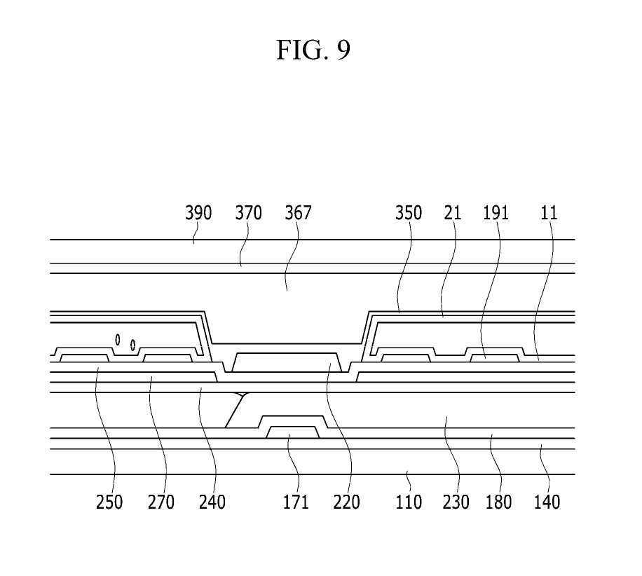

Hereinafter, the display device according to the exemplary embodiment of the present disclosure is described with reference to FIGS. 7 to 9.

First, the gate conductor including the gate line 121 is formed on the insulating substrate 110 made of transparent plastic, or the like.

The gate line 121 includes a wide end (not illustrated) for connection with the gate electrode 124 and another layer or an external driving circuit. The gate line 121 may be made of aluminum-based metals, such as aluminum (Al) and aluminum alloy, silver-based metals, such as silver (Ag) and silver alloy, copper-based metals, such as copper (Cu) and copper alloy, molybdenum-based metals, such as molybdenum (Mo) or molybdenum alloy, chromium (Cr), tantalum (Ta), titanium (Ti), and the like. However, the gate line 121 may also have a multilayer structure including at least two conductive layers having different physical properties.

The gate insulating layer 140 made of silicon nitride (SiNx), silicon oxide (SiOx), or the like is formed on the gate conductor 121. The gate insulating layer 140 may also have a multilayer structure including at least two conductive layers having different physical properties.

The semiconductor 154 made of amorphous silicon, polysilicon, or the like is formed on the gate insulating layer 140. The semiconductor 154 may include an oxide semiconductor.

An ohmic contact is formed on the semiconductor 154. The ohmic contact (not illustrated) may be made of materials, such as n+ hydrogenated amorphous silicon, which is doped with an n-type impurity, such as phosphorous, at a high concentration or may be made of silicide. The ohmic contact (not illustrated) is paired and thus may be disposed on the semiconductor 154. When the semiconductor 154 is the oxide semiconductor, the ohmic contact may be omitted.

The data lines 171 including the source electrode 173 and the data conductor including the drain electrode 175 are formed on the semiconductor 154 and the gate insulating layer 140.

The data line 171 includes a wide end (not illustrated) for connection with another layer or an external driving circuit. The data lines 171 transfer the data signals and extend mainly in a vertical direction to intersect the gate lines 121.

In this case, the data line 171 may have first curved parts having a curved shape to obtain a maximum transmittance of the liquid crystal display, and the first curved parts may have a V-letter shape by meeting each other at an intermediate region of a pixel area. The intermediate region of the pixel area may be further provided with a second curved part that is curved at a predetermined angle with respect to the first curved part.

The first curved part of the data line 171 may be curved by about 7° with respect to a vertical reference line forming an angle of 90° with respect to the direction in which the gate line 121 extends. The second curved part disposed in the intermediate region of the pixel area may be further curved by about 7° to about 15° with respect to the first curved part.

The source electrode 173 is a portion of the data line 171 and is disposed on the same line as the data line 171. The drain electrode 175 is formed to extend in parallel with the source electrode 173. Therefore, the drain electrode 175 is parallel with a portion of the data line 171.

The gate electrode 124, the source electrode 173, and the drain electrode 175 form the thin film transistor (TFT) along with the semiconductor 154, and the channel of the thin film transistor is formed in the semiconductor 154 between the source electrode 173 and the drain electrode 175.

The display device according to the exemplary embodiment of the present disclosure includes the source electrode 173, which is positioned on the same line as the data line 171, and the drain electrode 175, which extends in parallel with the data line 171, such that a width of the thin film transistor may be expanded without expanding the area occupied by the data conductor, thereby increasing an aperture ratio of the display device.

However, in the case of the display device according to another exemplary embodiment of the present disclosure, the source electrode 173 and the drain electrode 175 may have different forms.

The data line 171 and the drain electrode 175 may be made of refractory metals, such as molybdenum, chromium, tantalum, titanium, and the like or an alloy thereof and may have a multilayer structure including a refractory metal layer (not illustrated) and a low-resistance conductive layer (not illustrated). An example of the multilayer structure may include a double layer of a chromium or molybdenum (alloy) lower layer and an aluminum (alloy) upper layer and a triple layer of a molybdenum (alloy) lower layer, an aluminum (alloy) intermediate layer, and a molybdenum (alloy) upper layer. However, the data line 171 and the drain electrode 175 may be made of various metals or conductors in addition to the above materials.

The passivation layer 180a is disposed on the exposed portions of the data conductors 171, 173, and 175, the gate insulating layer 140, and the semiconductor 154

The passivation layer 180a may be made of an organic insulating material, an inorganic insulating material, or the like.

The color filters 230 are formed on the passivation layer 180, in each of the pixel areas PXs. Each color filter 230 may display one of primary colors such as three primary colors of red, green, and blue. The color filter 230 is not limited to the three primary colors of red, green, and blue and may also display cyan, magenta, yellow, white-based colors, and the like. Differently from the one illustrated, the color filter 230 may extend in a column direction along a gap between adjacent data lines 171.

An organic layer 240 is disposed on the color filter 230. The organic layer 240 may have a thickness thicker than that of the passivation layer 180 and a flat surface.

The organic layer 240 may be positioned in a display area in which the plurality of pixels are positioned and may not be positioned in a peripheral area in which a gate pad part, a data pad part, etc., are formed. Alternatively, the organic layer 240 may also be positioned in the peripheral area in which the gate pad part, the data pad part, etc., are formed.

The organic layer 240, the color filter 230, and the passivation layer 180 have contact holes 184.

The common electrode 270 is positioned on the organic layer 240. The common electrode 270 may be a plane shape and is positioned in the display area in which the plurality of pixels are positioned and is not be positioned in the peripheral area in which a gate pad part, a data pad part, etc., are formed.

The common electrode 270 is formed of a transparent conductive layer made of ITO or IZO.

An insulating layer 250 is disposed on the common electrode 270. The insulating layer 250 may be made of inorganic insulating materials such as silicon nitride (SiNx), silicon oxide (SiOx), and silicon nitride oxide (SiOxNy). The insulating layer 250 serves to protect the color filter 230, etc., made of the organic material and insulate the common electrode 270 and the pixel electrode 191. That is, even though the common electrode 270 is formed to overlap the pixel electrode 191, the insulating layer 250 is formed on the common electrode 270, and therefore, the common electrode 270 and the pixel electrode 191 may be prevented from being short-circuited with each other due to the contact with each other.

The pixel electrode 191 is disposed on the insulating layer 250. The pixel electrode 191 includes curved edges that are in parallel with the first curved part and the second curved part of the data line 171.

The pixel electrode 191 is formed of a transparent conductive layer made of ITO or IZO.

The pixel electrode 191 is physically and electrically connected to the drain electrode 175 through the contact holes 184, which are formed in the organic layer 240, the color filter 230, and the passivation layer 180, and thus is applied with the voltage from the drain electrode 175.

The pixel electrode 191 is applied with a data voltage from the drain electrode 175, and the common electrode 270 is applied with a reference voltage having a predetermined magnitude from a reference voltage applying unit that is disposed outside the display area.

The pixel electrode 191 and the common electrode 270 generate an electric field, whose strength depends on the applied voltage, and the liquid crystal molecules 310 of the liquid crystal layer positioned between the two electrodes 191 and 270 rotate in a direction that is in parallel with a direction of the electric field. The polarization of light passing through the liquid crystal layer is changed depending on the rotating direction of the liquid crystal molecules determined as described above.

The lower insulating layer 350 may be further formed on the pixel electrode 191, while being spaced apart from the pixel electrode 191 at a predetermined distance. The lower insulating layer 350 may be made of inorganic insulating materials such as silicon nitride (SiNx) and silicon oxide (SiOx).

The microcavity 305 is formed between the pixel electrode 191 and the lower insulating layer 350. That is, the microcavity 305 is enclosed by the pixel electrode 191 and the lower insulating layer 350. A width of the microcavity 305 may be variously changed depending on a size and a resolution of the display device.

The first alignment layer 11 is formed on the pixel electrode 191. The first alignment layer 11 may also be formed just on parts of the insulating layer 250 not covered with the pixel electrode 191.

The second alignment layer 21 is formed under the lower insulating layer 350 to face the first alignment layer 11.

The first alignment layer 11 and the second alignment layer 21 may be formed of a vertical alignment layer and may be made of an alignment material such as polyamic acid, polysiloxane, and polyimide. As illustrated in FIG. 3, the first and second alignment layers 11 and 21 may be connected to each other at the edge of the pixel area PX.

The liquid crystal layer formed of liquid crystal molecules 310 is formed in the microcavity 305, which is positioned between the pixel electrode 191 and the common electrode 350.

Further, the black matrix 220 is formed in the region between the adjacent color filters 230. In particular, as illustrated in FIG. 3, the black matrix 220 may be positioned on the pixel electrode 191 and the insulating layer 250 that is not covered with the pixel electrode 191. The black matrix 220 may be formed on a boundary part of the pixel area PX and the thin film transistor to prevent light from being leaked.

The black matrix 220 extends along the gate line 121 and thus extends up and down and may include the horizontal black matrix that covers the region in which the thin film transistor, etc., are positioned and the vertical black matrix that extends along the data line 171. That is, the horizontal black matrix may be formed in the liquid crystal injection hole forming region 307FP, and the vertical black matrix 220 may be formed in the partition wall part PWP. The color filter 230 and the black matrix 220 may overlap each other in some region. In some cases, the vertical black matrix may be omitted.

Next, the roof layer 360 is formed on the lower insulating layer 350. The roof layer 360 may be made of the organic material. The microcavity 305 is formed under the roof layer 360. The roof layer 360 may be hardened by a hardening process to keep the shape of the microcavity 305. The roof layer 360 is formed to be spaced apart from the pixel electrode 191 with the microcavity 305 disposed therebetween.

The roof layers 360 are each formed to cover the pixel area PX and the partition wall part PWP along the pixel row and are not formed in the liquid crystal injection hole forming area 307FP. The microcavity 305 is not formed under the roof layer 360, in the partition wall part PWP. Therefore, the thickness of the roof layer 360 positioned in the partition wall part PWP may be formed to be thicker than that of the roof layer 360 positioned in the pixel area. The thick region may be called a vertical support member 367. The upper surface and both sides of the microcavity 305 are formed to be covered with the roof layer 360.

The roof layer 360 is provided with the inlet 307 through which a portion of the microcavity 305 is exposed. The lower insulating layer 350 adjacent to the region in which the inlet 307 is formed may include the region that protrudes more than the roof layer 360.

The inlet 307 according to the exemplary embodiment of the present disclosure may be formed at one edge of the pixel area PX. For example, the inlet 307 may be formed to expose one surface of the microcavity 305 corresponding to a lower edge of the pixel area PX. Alternatively, the inlet 307 may be formed to correspond to an upper edge of the pixel area PX. That is, the inlet 307 may be formed at any one of the two edges of each microcavity 305 that face each other.

Since the microcavity 305 is exposed through the inlet 307, an aligning agent, the liquid crystal material, or the like may be injected into the microcavity 305 through the inlet 307.

The upper insulating layer 370 may be further formed on the roof layer 360. The upper insulating layer 370 may be made of inorganic insulating materials such as silicon nitride (SiNx) and silicon oxide (SiOx). The upper insulating layer 370 may be formed to cover the upper surface and the sides of the roof layer 360. The upper insulating layer 370 serves to protect the roof layer 360 made of an organic material and may be omitted in some cases.

The upper insulating layer 370 may contact the lower insulating layer 350 protruding more than the roof layer 360 in the region in which the inlet 307 is positioned. Further, the upper insulating layer 370 may have a stepped cross section due to a step between the region contacting the lower insulating layer 350 and the region covering the roof layer.

Further, the upper insulating layer 370 may be connected to the lower insulating layer 350. The upper insulating layer 370 may be connected to or overlap with the lower insulating layer 350 at an opposite position corresponding to the inlet 307, that is, in the region in which the support member 365 is positioned.

The capping layer 390 may be formed on the upper insulating layer 370. The capping layer 390 is formed to cover the inlet 307 through which a portion of the microcavity 305 would otherwise be exposed to the outside. That is, the capping layer 390 may encapsulate the microcavity 305 to prevent the liquid crystal molecules 310 formed in the microcavity 305 from being leaked to the outside. The capping layer 390 contacts the liquid crystal molecule 310 and therefore may be made of a material that does not react to the liquid crystal molecule 310. For example, the capping layer 390 may be made of parylene, and the like.

The capping layer 390 may also be made of a multilayer such as a double layer and a triple layer. The double layer may be formed of two layers that are made of different materials. The triple layer may be formed of three layers in which materials of the layers adjacent to each other are different from each other. For example, the capping layer 390 may include a layer made of the organic insulating material and a layer made of the inorganic insulating material.

Although not illustrated, the polarizers may be further formed on the upper and lower surfaces of the display device. The polarizer may be formed of the first polarizer and the second polarizer. The first polarizer may be attached to the lower surface of the substrate 110, and the second polarizer may be attached on the capping layer 390.

As described above, the display unit of the blind according to the exemplary embodiment of the present disclosure is positioned in the display panel, which has a structure in which the microcavity is formed on the flexible insulating substrate.

Generally, the existing display panel requires both the upper substrate and the lower substrate. As a result, there is a problem of misalignment between the upper substrate and the lower substrate when the display panel is curved. Further, since the thickness of the display panel is thick, it is difficult to store the display panel in a rolled-up form.

However, the display panel applied to the display unit of the blind according to the exemplary embodiment of the present disclosure is freely curved since the substrate is formed of the flexible plastic substrate. Further, since only one substrate is present in the display panel, the problem of the misalignment between the upper and lower substrates does not occur, and the thickness of the display panel may also be reduced.

Further, the display panel according to the exemplary embodiment of the present disclosure has the plurality of microcavities separated from each other in each pixel. Therefore, even when the display panel is curved or wound around the bar, the display panel may keep the flexible characteristics and may be prevented from being damaged.

That is, in the blind according to the exemplary embodiment of the present disclosure, the display unit including the display panel as described above is formed in the curtain region of the blind.

The display unit serves as the light blocking layer covering light when not displaying the image. The reason is that the polarizers, and the like are attached to the upper and lower portions of the display panel, and the display unit appears black when the display unit is not driven.

Therefore, when the display unit does not display an image, the display unit of the blind serves as the general light blocking layer. The display unit of the blind blocks external light, and a length thereof may be controlled while the blind goes up and down.

However, the display unit of the blind according to the exemplary embodiment of the present disclosure may include the display panel for displaying the image. Therefore, when the display unit is driven, the display unit of the blind itself serves as the single display device. In this case, the size of the display area may be freely controlled depending on the extent in which the blind is rolled up or rolled down. Further, when not being used, the display unit may be stored while being rolled up and may be used as the blind when the display unit is rolled down.

Therefore, the display unit may be used like a projector without a separate beam projector apparatus.

The reason is that in the case of the display panel according to the exemplary embodiment of the present disclosure, the plurality of microcavities are formed on the substrate made of plastic, and the liquid crystal layer is formed in the microcavity. That is, the substrate is formed of one sheet of flexible substrate, and therefore, even when the substrate is curved or bent, misalignment does not occur, the texture occurrence may be prevented, and the thickness is thin. Therefore the substrate may also be rolled in several folds.

While the present system and method have been described in connection with exemplary embodiments, it is to be understood that the present system and method are not limited to the disclosed embodiments. On the contrary, the present system and method cover various modifications and equivalent arrangements included within the spirit and scope of the appended claims.

<Description of symbols>

| | |
|---|---|
| 10: Upper fixed part | 20: Display unit |
| 30: Lower fixed part | 40: Light source |
| 11: First alignment layer | 21: Second alignment layer |
| 110: Substrate | 180: Passivation layer |
| 121: Gate conductor | 171: Data conductor |
| 154: Semiconductor | 220: Black matrix |
| 250: Insulating layer | 350: Lower insulating layer |
| 370: Upper insulating layer | 390: Capping layer |
| 310: Liquid crystal layer | 360: Roof layer |

What is claimed is:

1. A blind, comprising:
an upper fixed part; and
a display unit connected to the upper fixed part,
wherein the display unit includes:
a substrate,
a thin film transistor formed on the substrate;
a pixel electrode connected to the thin film transistor;
a roof layer facing the pixel electrode; and
a liquid crystal layer formed as a plurality of microcavities between the pixel electrode and the roof layer, and
the display unit is configured to have a first state in which the display unit is wound around the upper fixed part and a second state in which the display unit is unwound from the upper fixed part.

2. The blind of claim 1, wherein:
the blind is configured to display an image on the display unit and block external light when the image is not displayed.

3. The blind of claim 1, further comprising:
a lower fixed part connected to a lower portion of the display unit.

4. The blind of claim 1, wherein:
the upper fixed part is formed in a bar shape.

5. The blind of claim 1, wherein:
the upper fixed part is provided with a light source.

6. The blind of claim 5, wherein:
a lower portion of the substrate is provided with a light guide plate.

7. The blind of claim 1, wherein:
the substrate is flexible.

8. The blind of claim 1, further comprising:
polarizers formed on a lower portion of the substrate and an upper portion of the roof layer.

9. The blind of claim 1, further comprising:
common electrodes formed under the roof layer with the pixel electrode and the liquid crystal layer disposed therebetween.

10. The blind of claim 1, further comprising:
a common electrode formed on a pixel electrode, while being insulated from the pixel electrode.

11. The blind of claim 1, wherein:
the upper fixed part is provided with a driver driving the display unit.

12. The blind of claim 1, further comprising:
a capping layer encapsulating the microcavity.

13. The blind of claim 2, wherein:
the display unit appears black when power is not supplied to the display unit.

14. The blind of claim 3, wherein:
the lower fixed part is provided with a light source.

15. The blind of claim 1, further comprising:
a color filter layer formed between the thin film transistor and the pixel electrode.

16. The blind of claim 1, wherein:
the roof layer fills between the liquid crystal layer formed as the plurality of microcavities to form a partition wall.

17. The blind of claim 16, wherein:
a region in which the partition wall of the roof layer is not formed is provided with an inlet.

18. The blind of claim 10, wherein:
the pixel electrode has a plurality of cutouts.
